(19) United States
(12) Patent Application Publication
(10) Pub. No.: US 2022/0063081 A1
(43) Pub. Date: Mar. 3, 2022

(54) POWER TOOL

(71) Applicant: MAKITA CORPORATION, Anjo-shi (JP)

(72) Inventor: Shogo TOMINAGA, Anjo-shi (JP)

(73) Assignee: MAKITA CORPORATION, Anjo-shi (JP)

(21) Appl. No.: 17/358,646

(22) Filed: Jun. 25, 2021

(30) Foreign Application Priority Data
Sep. 2, 2020 (JP) 2020-147755

(51) Int. Cl. B25F 5/02; B25B 21/00; B25F 5/00

(52) U.S. Cl. CPC B25F 5/02; B25F 5/001; B25B 21/007

(57) ABSTRACT

A power tool includes an illuminating portion as an indicator with improved viewability. A screwdriver includes a motor, an output unit driven by the motor, a housing accommodating the motor and including a grip and a battery mount below the grip, a switch held on the grip, a control circuit board accommodated in the battery mount, and a light emitter on an upper surface of the control circuit board. The batter mount has an upper surface with a first hole located in a left area or a right area of the upper surface. The light emitter emits light viewable through the first hole.

### CROSS-REFERENCE TO RELATED APPLICATIONS

This application claims the benefit of priority to Japanese Patent Application No. 2020-147755, filed on Sep. 2, 2020, the entire contents of which are hereby incorporated by reference.

### BACKGROUND

### 1. Technical Field

The present disclosure relates to a power tool such as a screwdriver.

### 2. Description of the Background

A power tool such as a screwdriver includes a motor and an output unit driven by the motor. The motor is accommodated in a housing including a grip extending downward and a battery mount below the grip. Japanese Unexamined Patent Application Publication No. 2018-111206 describes, in FIG. 9, a structure including a battery mount accommodating a terminal mount electrically connectable to a battery pack and a control circuit board located above the battery mount. The structure also includes an operation panel (illuminating portion) on the upper surface of the battery mount. The operation panel includes a light switch, a power-level indicative switch, and a battery indicator. When the power-level indicative switch is depressed, the battery indicator shows the remaining power level of the battery pack by illuminating the corresponding number of graduations.

### BRIEF SUMMARY

The known operation panel is located laterally in the middle on the upper surface of the battery mount. Thus, when the grip is held by one hand, the illuminating operation panel is covered by the hand and is unviewable from behind. This is not limited to the operation panel indicating the remaining power level of the battery pack. For an operation panel for, for example, a screwdriver switchable between multiple operational modes, a selected operational mode indicated by illumination may also be unviewable.

One or more aspects of the present disclosure are directed to a power tool including an illuminating portion as an indicator with improved viewability.

A first aspect of the present disclosure provides a power tool, including:
a motor;
an output unit driven by the motor;
a housing accommodating the motor, the housing including
   a grip, and
   a battery mount below the grip, the battery mount having an upper surface with a first hole located in a left area or a right area of the upper surface;
a switch held on the grip;
a control circuit board accommodated in the battery mount; and
a light emitter on an upper surface of the control circuit board, the light emitter being configured to emit light viewable through the first hole.

A second aspect of the present disclosure provides a power tool, including:
a motor;
an output unit driven by the motor;
a housing accommodating the motor, the housing including
   a grip, and
   a battery mount below the grip, the battery mount having an upper surface receiving
a plate member with a first hole located in a left area or a right area of the upper surface;
a switch held on the grip;
a control circuit board accommodated in the battery mount; and
a light emitter on an upper surface of the control circuit board, the light emitter being configured to emit light viewable through the first hole.

A third aspect of the present disclosure provides a power tool, including:

a motor;
an output unit driven by the motor;
a housing accommodating the motor, the housing including
   a grip, and
   a battery mount below the grip;
a switch held on the grip; and
an illuminating portion located in a left area or a right area on an upper surface of the battery mount, the illuminating portion being configured to indicate an operational mode.

The power tool according to the above aspects of the present disclosure includes the illuminating portion as an indicator with improved viewability.

### BRIEF DESCRIPTION OF DRAWINGS

FIG. 1 is a perspective view of an auto feed screwdriver.

FIG. 2 is a side view of the auto feed screwdriver.

FIG. 3 is a plan view of the auto feed screwdriver.

FIG. 4 is a cross-sectional view taken along line A-A in FIG. 3.

FIG. 5 is a perspective view of a body housing without a left half housing and a motor.

FIG. 6 is an exploded perspective view of a switch plate assembly.

FIG. 7 is an enlarged cross-sectional view taken along line B-B in FIG. 3.

### DETAILED DESCRIPTION

Embodiments of the present disclosure will now be described with reference to the drawings.

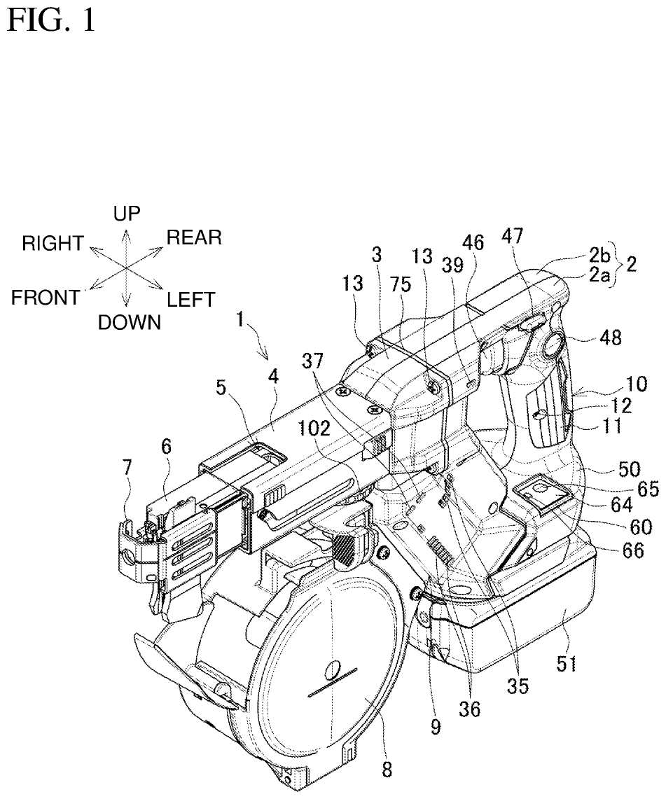

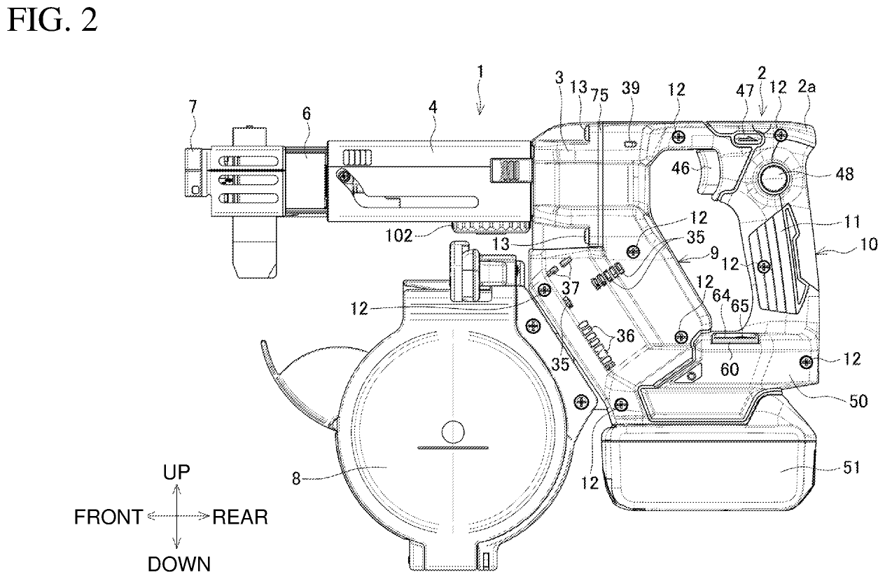

FIG. 1 is a perspective view of an auto feed screwdriver (hereafter simply referred to as a screwdriver) 1 as an example of a power tool. FIG. 2 is a side view of the screwdriver 1.

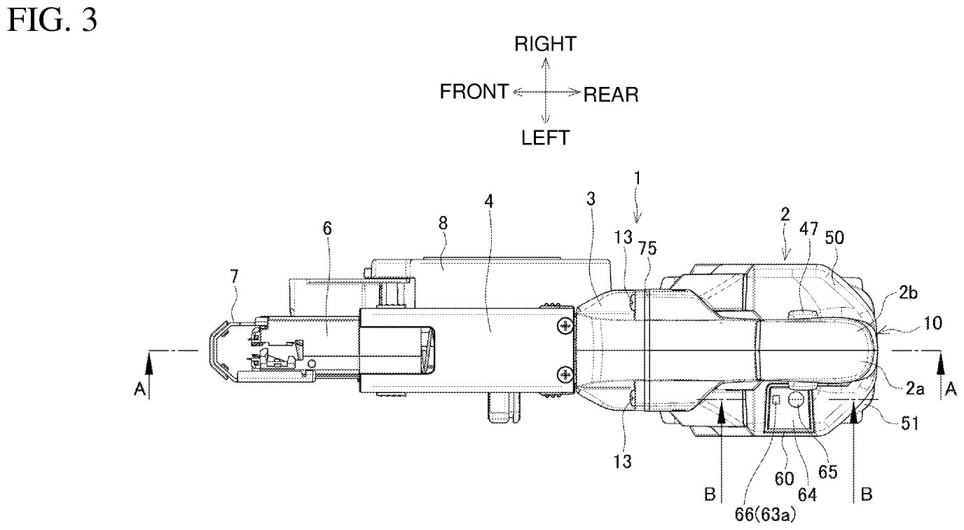

FIG. 3 is a plan view of the screwdriver 1.

The screwdriver 1 includes a body housing 2, a gear housing 3, a casing 4, an output unit 5, a feeder box 6, a stopper base 7, and a magazine 8.

The gear housing 3 is cylindrical and joined to the front of the body housing 2. The casing 4 is cylindrical and joined to the front of the gear housing 3 to extend frontward. The output unit 5 is inside the gear housing 3 and the casing 4. The feeder box 6 is in front of the casing 4. The stopper base 7 is at the front end of the feeder box 6. The magazine 8 is below the casing 4 and in front of the body housing 2. The magazine 8 accommodates collated screws.

The body housing 2 includes a motor housing 9 and a grip housing 10 that are integrated together. The upper end of the motor housing 9 connects to the gear housing 3. The motor housing 9 extends linearly and diagonally with its lower end located more rearward than its upper end. The grip housing 10 is in a loop and has its upper and lower ends connected to the rear of the motor housing 9. The grip housing 10 includes a grip 11 extending vertically.

The body housing 2 includes a pair of left and right half housings 2a and 2b. The half housings 2a and 2b are joined together with multiple screws 12 placed from the left. The gear housing 3 is joined to the upper front of the body housing 2 with four screws 13 placed from the front.

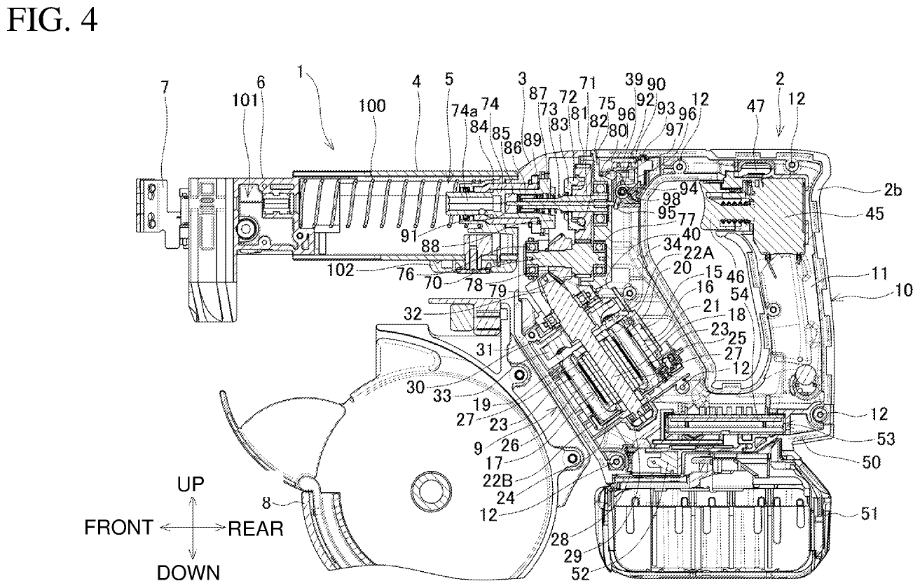

As shown in FIG. 4, the motor housing 9 accommodates a motor 15. The motor 15 is an inner-rotor brushless motor including a cylindrical stator 16 and a rotor 17 contained in the stator 16. The motor 15 is supported in the motor housing 9 with a rotational shaft 18 of the rotor 17 extending diagonally upward along the motor housing 9.

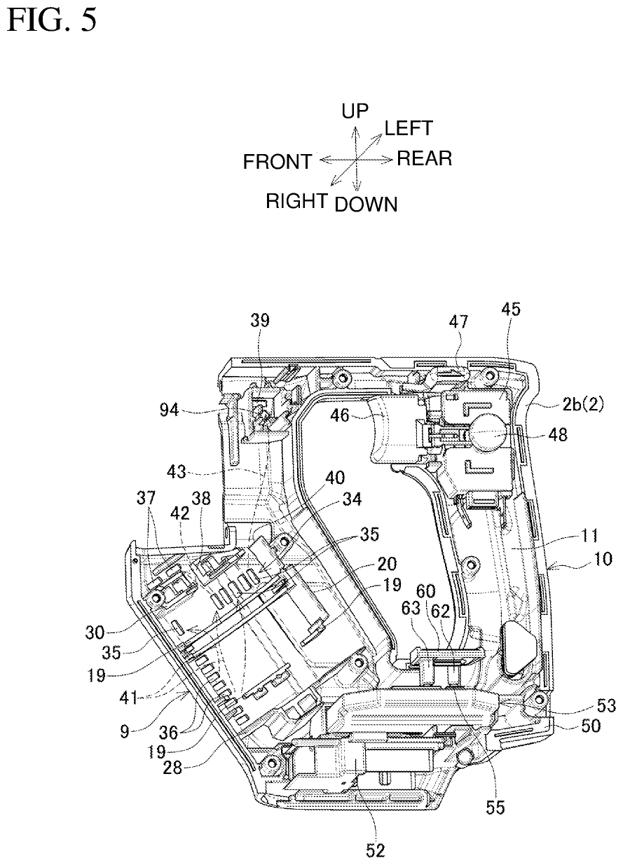

The motor 15 is adjacent to the inner front surface of the motor housing 9. As shown in FIG. 5, the motor housing 9 includes support ribs 19 extending upright from the inner surface of the motor housing 9. The support ribs 19 support the stator 16 at a frontward position. The motor housing 9 includes, above and rearward from the stator 16, a side wall 20 extending upright from the inner surface of the motor housing 9. The side wall 20 connects with some support ribs 19 and extends parallel to the rotational shaft 18.

The stator 16 includes a stator core 21, upper and lower insulators 22A and 22B, and multiple coils 23. A sensor circuit board 24 is fastened with screws to the lower insulator 22B from below. The sensor circuit board 24 includes a rotation detecting element (not shown) on the upper surface. The rotation detecting element detects the magnetic field of multiple permanent magnets 27 included in the rotor 17. The wire of each coil 23 forms a three-phase connection. The power line for the three-phase connection extends from behind the insulator 22B through a connector 25 to a controller 53 (described later). The signal wire from the rotation detecting element also extends from behind the sensor circuit board 24 to the controller 53.

The rotor 17 includes the rotational shaft 18 and a rotor core 26 surrounding the rotational shaft 18. The permanent magnets 27 are fixed inside the rotor core 26.

The rotational shaft 18 has its lower end rotatably supported on a lower wall 28 extending upright from the inner surface of the motor housing 9 with a bearing 29. The lower wall 28 is spaced from the lower end of the side wall 20. The connector 25 protrudes into the motor housing 9 from between the lower wall 28 and the side wall 20.

The rotational shaft 18 has its upper portion rotatably supported on an upper wall 30 extending upright from the inner surface of the motor housing 9 with a bearing 31. The rotational shaft 18 includes a pinion 32 at its upper end and protrudes into the gear housing 3.

The rotational shaft 18 receives a fan 33 between the stator 16 and the bearing 31. The fan 33 is a centrifugal fan. The fan 33 is accommodated in a fan compartment 34 surrounded by the upper support rib 19, the side wall 20, and the upper wall 30.

The motor housing 9 has multiple lower outlets 35 in each of its lateral side surfaces outward from the fan 33. The multiple lower outlets 35 are aligned diagonally downward and are orthogonal to the rotational shaft 18. Below the fan 33, the motor housing 9 has multiple inlets 36 in each of its lateral side surfaces. The multiple inlets 36 are aligned along the axis of the rotational shaft 18. The inlets 36 have a larger total opening area than the lower outlets 35.

Above the upper wall 30, the motor housing 9 has two intermediate outlets 37 in each of its lateral side surfaces. The upper wall 30 has a slit 38 (FIG. 5), which connects the space above the upper wall 30 on the right and left of the bearing 29 to the fan compartment 34.

Behind the gear housing 3, the body housing 2 has an upper outlet 39 in each of its lateral side surfaces. The side wall 20 and the upper wall 30 are separated by a clearance 40, which connects the space behind the gear housing 3 to the fan compartment 34.

As shown in FIG. 5, the body housing 2 thus has a first cooling channel 41, a second cooling channel 42, and a third cooling channel 43. As the fan 33 rotates, the first cooling channel 41 allows the outside air drawn in through the inlets 36 to flow upward in the motor housing 9 to the fan compartment 34 and be discharged through the lower outlets 35. The second cooling channel 42 allows a portion of the air undischarged through the lower outlets 35 to flow upward through the slit 38 and be discharged through the intermediate outlets 37. The third cooling channel 43 allows another portion of the air undischarged through the lower outlets 35 to flow upward through the clearance 40 and be discharged through the upper outlets 39.

The grip 11 includes, in its upper portion, a switch 45 with a trigger 46 protruding frontward. A forward-reverse switch lever 47 is located above the switch 45. A forward-reverse lever switch (not shown) is located between the switch 45 and the forward-reverse switch lever 47. The forward-reverse lever switch performs a switching operation in response to an operation on the forward-reverse switch lever 47. A lock button 48 is located below the forward-reverse switch lever 47 to lock the trigger 46 at a depressed position.

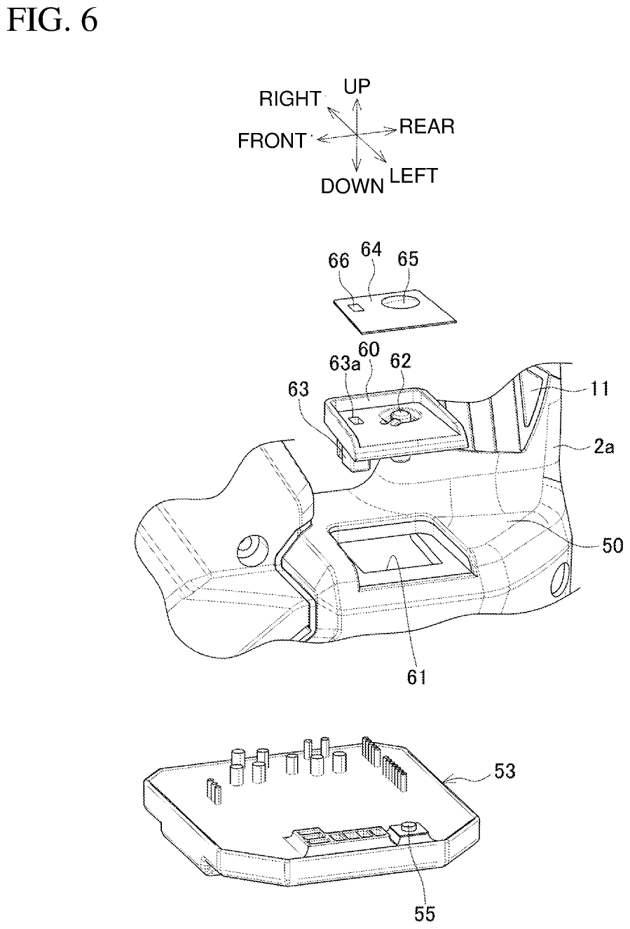

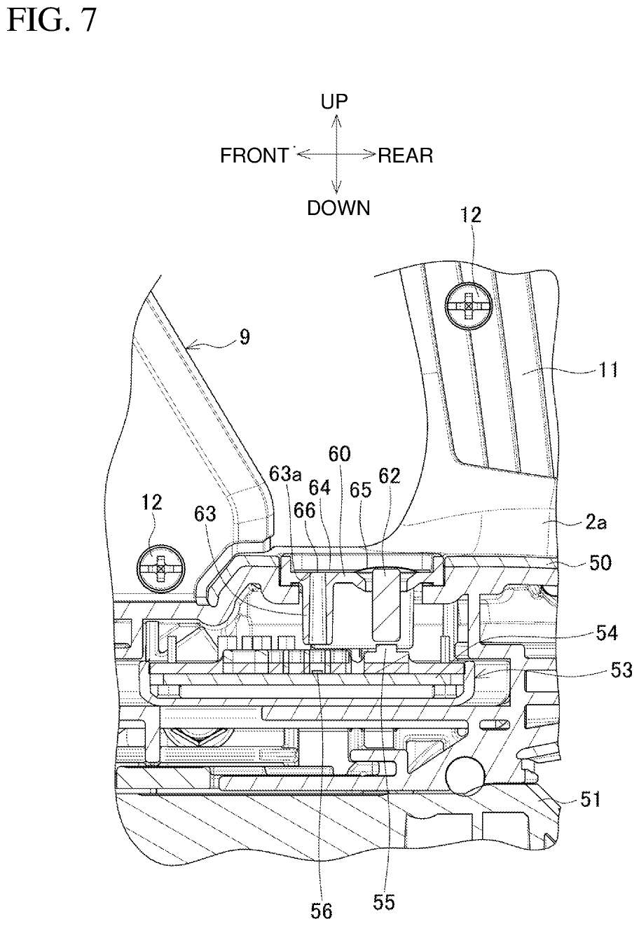

A battery mount 50 is located below the grip housing 10 to receive a battery pack 51 in a manner slidable from the rear. The battery mount 50 accommodates a terminal mount 52. The terminal mount 52 is electrically connectable to the battery pack 51. The battery mount 50 also accommodates a controller 53 above the terminal mount 52. The controller 53 includes a control circuit board 54. As shown in FIGS. 6 and 7, the control circuit board 54 includes, in addition to a microcomputer and switching elements, a button switch 55 for mode switching and a light-emitting diode (LED) 56 for mode switching indication. The button switch 55 and the LED 56 are located at the left edge of the control circuit board 54.

The half housing 2a accommodates a switch plate 60 above and in a left area of the control circuit board 54. The switch plate 60 is rectangular as viewed in plan. The switch plate 60 is fitted in a hole 61 in the upper left surface of the battery mount 50. The hole 61 is rectangular as viewed in plan. The switch plate 60 is integral with an operation rod 62. The operation rod 62 moves downward as depressed from above. As shown in FIG. 7, the operation rod 62 is immediately above the button switch 55.

In front of the operation rod 62, the switch plate 60 has a hollow rectangular prism 63 protruding downward. The hollow rectangular prism 63 is integral with the switch plate 60. The hollow rectangular prism 63 is immediately above the LED 56. The hollow rectangular prism 63 has a through-hole defining an opening 63a in the upper surface of the switch plate 60.

The switch plate 60 receives an indicator sheet 64 adhering to the upper surface of the switch plate 60. The indicator sheet 64 includes a button indicator 65 and an illuminating portion 66. The button indicator 65 covers the upper surface of the operation rod 62. The illuminating portion 66 is transparent and covers the opening 63a of the hollow rectangular prism 63.

As shown in FIG. 4, the output unit 5 includes a countershaft 70, a first spindle 71, a clutch cam 72, a coil spring 73, and a second spindle 74. A retainer plate 75 is joined between the gear housing 3 and the body housing 2.

The countershaft 70 is accommodated in the gear housing 3 with the axis extending in the front-rear direction. The countershaft 70 has its front end rotatably supported in the gear housing 3 with a bearing 76 and its rear end rotatably supported on the retainer plate 75 with a bearing 77. The countershaft 70 receives a bevel gear 78 on its middle portion in a manner rotatable together with the countershaft 70. The bevel gear 78 meshes with the pinion 32 on the rotational shaft 18. The countershaft 70 is integral with a first gear 79 on its rear portion.

The first spindle 71 is located above the countershaft 70 with its axis extending in the front-rear direction. The first spindle 71 has its rear end rotatably supported on the retainer plate 75 with a bearing 80. The first spindle 71 receives a second gear 81 on its rear portion in a manner rotatable together with the first spindle 71. The second gear 81 meshes with the first gear 79.

The clutch cam 72 is coupled to the second gear 81 with multiple balls 82 in a manner rotatable together with the second gear 81. The clutch cam 72 has a rear cam 83 on its front surface.

The second spindle 74 is located in front of and coaxially with the first spindle 71. The second spindle 74 is held by a sleeve 84 in a manner rotatable and movable back and forth. The sleeve 84 is held in the gear housing 3 and the casing 4.

The second spindle 74 has a blind hole 85 in its rear portion. The blind hole 85 in the second spindle 74 receives the front portion of the first spindle 71. The blind hole 85 receives a bearing 86. The front end of the first spindle 71 is loosely received through the bearing 86 and supported in the blind hole 85 in a manner rotatable coaxially with the second spindle 74.

The coil spring 73 is externally mounted on the first spindle 71. The rear end of the coil spring 73 abuts against the front surface of the clutch cam 72. The front end of the coil spring 73 abuts against the rear surface of the bearing 86.

The second spindle 74 includes a flange 87 on its rear end. The flange 87 has a front cam 88 on its rear surface. The front cam 88 faces the rear cam 83 on the clutch cam 72. The front cam 88 and the rear cam 83 engage with each other in the forward and reverse rotational directions when in contact with each other.

The second spindle 74 is urged frontward by the coil spring 73. The sleeve 84 supports a stopper 89 at its rear end. The flange 87 on the second spindle 74 comes in contact with the stopper 89 to restrict the forward movement of the second spindle 74.

The second spindle 74 includes a bit holder 74a at its front end. The bit holder 74a can receive a bit or a tip tool such as a screwdriver bit in a detachable manner from the front.

The body housing 2 accommodates a push-drive assembly 90. The push-drive assembly 90 enables a push-drive mode. The push-drive assembly 90 includes a rod 91, a lever 92, and a sensor board 93.

The rod 91 is the shaft of the first spindle 71 and is movable back and forth independently of the first spindle 71. The rear end of the rod 91 protrudes through the retainer plate 75 into the body housing 2.

The lever 92 is located behind the retainer plate 75. The lever 92 is rotatably held by a lateral boss 94 protruding from the inner surface of the body housing 2. The lever 92 includes a pressing piece 95 and a detection piece 96. The pressing piece 95 protrudes downward behind the rod 91. The detection piece 96 protrudes upward behind the pressing piece 95. The detection piece 96 includes a magnet 97.

The sensor board 93 is located behind the detection piece 96. The sensor board 93 includes a magnetic sensor, such as a Hall element. The sensor board 93 can detect changes in the magnetic field of the magnet 97 resulting from rotation of the detection piece 96. The lever 92 is normally at a first rotational position (indicated by the solid line in FIG. 4) at which the detection piece 96 is in contact with the front surface of the sensor board 93 under the urging force from a torsion spring 98.

The rod 91 is at an advanced position at which the rod 91 is pressed by the pressing piece 95 of the lever 92 at the first rotational position. The front end of the rod 91 at the advanced position is in contact with the inner bottom surface of the blind hole 85 in the second spindle 74 at the advanced position.

When the rod 91 retracts, the rear end of the rod 91 presses the pressing piece 95 of the lever 92 backward, rotating the lever 92 to a second rotational position indicated by the two-dot chain line. The detection piece 96 then rotates and separates forward from the sensor board 93. The sensor board 93 detects the change in the magnetic field resulting from the movement of the magnet 97 and outputs an on-signal. The microcomputer in the control circuit board 54 receives operation signals from the switch 45, the forward-reverse lever switch for the forward-reverse switch lever 47, the sensor board 93, and the button switch 55. The microcomputer specifies the rotation direction of the motor 15 based on the signal from the forward-reverse lever switch and drives the motor 15. The microcomputer specifies an operational mode based on the operation signal from the button switch 55.

The feeder box 6 is urged by a coil spring 100 to an advanced position at which the feeder box 6 protrudes from the casing 4. The feeder box 6 receives collated screws (not shown) fed from the magazine 8 from below. The feeder box 6 includes a feeder 101. The feeder 101 feeds, by retracting against the urging force from the coil spring 100, one screw at a time to the position at which the bit tightens the screw.

The stopper base 7 is mounted on the feeder box 6 at the position adjustable relative to the feeder box 6 in the front-rear direction. The mounting position is adjustable in accordance with the length of the screw. A depth adjustment dial 102 is used to adjust the amount of protrusion of the bit from the stopper base 7. The depth of the screw to be tightened can be specified with the depth adjustment dial 102.

For the screwdriver 1 according to the present embodiment, depressing the button indicator 65 on the switch plate 60 moves the operation rod 62 downward to turn on the button switch 55. The microcomputer then switches the operational mode to a push-drive mode and turns on the LED 56. The LED 56 emits light through the hollow rectangular prism 63 to the opening 63a to illuminate the illuminating portion 66.

When the button indicator 65 is depressed again, the operation rod 62 is moved downward to turn off the button switch 55. The microcomputer then switches the operational mode to a normal mode and turns off the LED 56. This stops illuminating the illuminating portion 66.

An operator gripping the grip 11 with the right hand can depress the button indicator 65 on the switch plate 60 with the left hand. The switch plate 60 on the upper left surface of the battery mount 50 is easily operable.

In response to the operational mode being switched, the illuminating portion 66 starts or stops illuminating to allow the operational mode switching to be viewable. The illuminating portion 66 on the upper left surface of the battery mount 50 and in front of the grip 11 is not covered by the right hand gripping the grip 11. The operator can thus easily view the illuminating portion 66 either illuminating or not illuminating.

The operations in specific operational modes will now be described. The normal mode is first described.

A bit is attached to the bit holder 74a in the second spindle 74. The forward-reverse switch lever 47 is set to a forward-rotation position. The operator then grips the grip 11 and places the stopper base 7 onto the surface of a workpiece, such as a plasterboard. The operator then depresses the trigger 46. This turns on the switch 45, causing power to be supplied from the battery pack 51 to the motor 15 through the control circuit board 54. The rotor 17 thus rotates forward to transmit the rotation of the rotational shaft 18 from the pinion 32 to the countershaft 70. As the countershaft 70 rotates at a reduced speed, the first spindle 71 and the clutch cam 72 also rotate forward together with the countershaft 70. In this state, the second spindle 74 is at the advanced position, without the front cam 88 being engaged with the rear cam 83 on the clutch cam 72. Thus, the second spindle 74 does not rotate.

The operator then pushes the grip 11 to move the screwdriver 1 forward. In this state, the feeder box 6 retracts against the urging force from the coil spring 100. At the same time, the feeder 101 feeds, from the collated screws, one screw, which is placed in front of the bit. When the screw comes in contact with the workpiece, the second spindle 74, together with the bit, retracts against the urging force from the coil spring 73. The front cam 88 on the second spindle 74 then engages with the rear cam 83 to transmit the rotation of the clutch cam 72 to the second spindle 74. This rotates the bit forward with the second spindle 74, tightening the screw into the workpiece.

As the screw is tightened further, the screwdriver 1 moves forward. The stopper base 7 then comes in contact with the casing 4. After that, the second spindle 74 alone moves forward as the screw is tightened further. When the front cam 88 separates from the rear cam 83, the rotation is no longer transmitted to the second spindle 74 to complete the screw tightening. The operator then stops depressing the trigger 46 to turn off the switch 45. This stops the rotation of the rotor 17. When the bit is separated from the screw, the feeder box 6 returns to the advanced position under the urging force from the coil spring 100. The second spindle 74 also returns to the advanced position under the urging force from the coil spring 73. Thus, when the operator pushes the grip 11 to move the screwdriver 1 forward, the next screw is fed and is tightened. This process is repeated for continuous tightening of screws.

In the push-drive mode, depressing the trigger 46 does not activate the motor 15. When the stopper base 7 is pressed against a workpiece to move the screwdriver 1 forward and retract the feeder box 6 and the second spindle 74, the rod 91 in contact with the inner bottom surface of the blind hole 85 retracts. This causes the rear end of the rod 91 to come in contact with the pressing piece 95 of the lever 92, rotating the lever 92 to the second rotational position. This causes the sensor board 93 to output an on-signal, causing the microcomputer to drive the motor 15. The front cam 88 then engages with the rear cam 83 to transmit the rotation of the clutch cam 72 to the second spindle 74. The bit rotates forward, together with the second spindle 74, to enable tightening of a screw.

In any operational mode, outside air is drawn in through the inlets 36 in the side surfaces of the body housing 2 as the fan 33 rotates with the rotation of the rotational shaft 18. The outside air drawn in through the inlets 36 flows through the first cooling channel 41 and then between the stator 16 and the rotor 17 and is discharged outside through the lower outlets 35. This cools the motor 15. A portion of the outside air undischarged through the lower outlets 35 flows through the second cooling channel 42 and then the slit 38 and is discharged outside through the intermediate outlets 37. This cools the bearing 31. Another portion of the outside air undischarged through the lower outlets 35 flows through the third cooling channel 43 and then the clearance 40 and is discharged through the upper outlets 39. This cools the retainer plate 75 and the gear housing 3.

The screwdriver 1 according to the present embodiment includes the motor 15 and the output unit 5 driven by the motor 15. The screwdriver 1 also includes the body housing 2 (housing) that accommodates the motor 15. The body housing 2 includes the grip 11 and the battery mount 50 below the grip 11. The screwdriver 1 also includes the switch 45 held on the grip 11, the control circuit board 54 accommodated in the battery mount 50, and the LED 56 (light emitter) mounted on the upper surface of the control circuit board 54. The battery mount 50 has the opening 63a (first hole) in its upper left surface to allow the light emission from the LED 56 to be viewable.

This structure allows light to be easily viewable through the opening 63a when the grip 11 is gripped, and improves the viewability of the illuminating portion 66 as an indicator.

The battery mount 50 receives the switch plate 60 (plate member) in the hole 61 (second hole) on its upper left surface. The switch plate 60 has the opening 63a. The switch plate 60 thus reliably allows the illuminating portion 66 to be viewable.

The switch plate 60 includes the button indicator 65 (operation part) to cause light emission from the LED 56. The button indicator 65 is thus also easily viewable and operable.

The button indicator 65 is used to switch the operational mode. The button indicator 65 is operated for easily switching the operational modes.

The opening 63a is in the switch plate 60 and is a through-hole in the hollow rectangular prism 63 (tube) located immediately above the LED 56. Thus, the light from the LED 56 can be reliably guided to the opening 63a.

The body housing 2 includes the left and right half housings 2a and 2b. The hole 61 is formed in the left half housing 2a. The hole 61 can thus be formed easily.

The battery mount 50 includes the switch plate 60 having the opening 63a in its upper left surface to allow the light emission from the LED 56 to be viewable.

The battery mount 50 also includes the illuminating portion 66 to indicate the operational mode on the upper left surface. This structure allows light to be easily viewable through the opening 63a when the grip 11 is gripped, and improves the viewability of the illuminating portion 66 as an indicator.

The grip 11 is laterally in the middle of the body housing 2. The hand gripping the grip 11 is thus less likely to block the opening 63a and decrease viewability.

The opening 63a is located frontward from the grip 11. The hand gripping the grip 11 is thus less likely to block the opening 63a and decrease viewability.

The light emitter includes the LED 56, which emits light clearly viewable through the opening 63a.

The body housing 2 is joined with the gear housing 3 accommodating the output unit 5. The body housing 2 also accommodates the fan 33 rotatable by the motor 15. The body housing 2 also has the third cooling channel 43 (cooling channel) to allow an airflow through the third cooling channel 43 to cool the gear housing 3 as the fan 33 rotates. The output unit 5 can thus be cooled through the gear housing 3.

Modifications will now be described.

The switch plate may be circular, oval, or in other shapes as viewed in plan. The tube forming the opening (hole) may be circular or in other shapes, rather than being rectangular. The dimensions are also not limited to the above examples. For the opening not immediately above the LED, the tube may extend diagonally.

The hole and the operation part may be reversed in the front-rear direction or may be arranged laterally.

The housing may integrally have the hole and the operation part, instead of receiving a separate switch plate.

The screwdriver may have multiple light emitters such as LEDs and holes corresponding to its operational modes. The light emitter and the hole may have uses other than for the operational mode switching. The light emitter and the hole may be used to indicate the remaining battery power level.

The hole and the operation part may be located in a right area of the housing, rather than in the left area. The hole and the operation part may be reversed in the lateral direction.

The housing may include components other than the left and right half housings.

The housing may be dividable into front and rear parts.

The grip may be shaped other than in a loop. The grip may be linear and protrude downward from the output unit and may include the battery mount on its lower end.

The screwdriver may be used with other screws rather than with collated screws. The present disclosure is also applicable to power tools other than screwdrivers, such as impact drivers, impact wrenches, and driver drills.

### REFERENCE SIGNS LIST

1 auto feed screwdriver
2 body housing
3 gear housing
4 casing
5 output unit
9 motor housing
10 grip housing
11 grip
15 motor
18 rotational shaft
50 battery mount
53 controller
54 control circuit board
55 button switch
56 LED
60 switch plate
61 hole
62 operation rod
63 hollow rectangular prism
63a opening
64 indicator sheet
65 button indicator
66 illuminating portion
71 first spindle
72 clutch cam
73 coil spring
74 second spindle
90 push-drive assembly
91 rod
92 lever
93 sensor board

What is claimed is:

1. A power tool, comprising:
a motor;
an output unit driven by the motor;
a housing accommodating the motor, the housing including
a grip, and
a battery mount below the grip, the battery mount having an upper surface with a first hole located in a left area or a right area of the upper surface;
a switch held on the grip;
a control circuit board accommodated in the battery mount; and
a light emitter on an upper surface of the control circuit board, the light emitter being configured to emit light viewable through the first hole.

2. The power tool according to claim 1, wherein
the battery mount includes
a plate member having the first hole, and
a second hole located in the upper surface and receiving the plate member.

3. The power tool according to claim 2, wherein
the plate member includes an operation part configured to cause light emission from the light emitter.

4. The power tool according to claim 3, wherein
the operation part is operable to switch an operational mode.

5. The power tool according to claim 2, wherein
the first hole in the plate member is a through-hole in a tube immediately above the light emitter.

6. The power tool according to claim 2, wherein
the housing includes
a first half housing with the second hole, and
a second half housing joined laterally to the first half housing.

7. A power tool, comprising:
a motor;
an output unit driven by the motor;
a housing accommodating the motor, the housing including
a grip, and
a battery mount below the grip, the battery mount having an upper surface receiving
a plate member with a first hole located in a left area or a right area of the upper surface;
a switch held on the grip;
a control circuit board accommodated in the battery mount; and
a light emitter on an upper surface of the control circuit board, the light emitter being configured to emit light viewable through the first hole.

8. The power tool according to claim 7, wherein
the plate member includes an operation part configured to cause light emission from the light emitter.

9. The power tool according to claim 8, wherein
the operation part is operable to switch an operational mode.

10. The power tool according to claim 7, wherein
the first hole in the plate member is a through-hole in a tube immediately above the light emitter.

11. The power tool according to claim 7, wherein
the housing includes
a first half housing including the plate member, and
a second half housing joined laterally to the first half housing.

12. The power tool according to claim 1, wherein
the grip is laterally in a middle portion of the housing.

13. The power tool according to claim 12, wherein
the first hole is located frontward from the grip.

14. The power tool according to claim 1, wherein
the light emitter includes a light-emitting diode.

15. The power tool according to claim 1, further comprising:
a gear housing accommodating the output unit and joined to the housing; and
a fan rotatable as driven by the motor,
wherein the housing has a cooling channel to allow an airflow through the cooling channel to cool the gear housing in response to rotation of the fan.

16. The power tool according to claim 3, wherein
the first hole in the plate member is a through-hole in a tube immediately above the light emitter.

17. The power tool according to claim 4, wherein
the first hole in the plate member is a through-hole in a tube immediately above the light emitter.

18. The power tool according to claim 3, wherein
the housing includes
a first half housing with the second hole, and
a second half housing joined laterally to the first half housing.

19. The power tool according to claim 4, wherein
the housing includes
a first half housing with the second hole, and
a second half housing joined laterally to the first half housing.

20. A power tool, comprising:
a motor;
an output unit driven by the motor;
a housing accommodating the motor, the housing including
a grip, and
a battery mount below the grip;
a switch held on the grip; and
an illuminating portion located in a left area or a right area on an upper surface of the battery mount, the illuminating portion being configured to indicate an operational mode.
